(19) United States
(12) Patent Application Publication
(10) Pub. No.: US 2026/0013674 A1
(43) Pub. Date: Jan. 15, 2026

(54) METHOD AND APPARATUS FOR BLENDING CONTENTS WITH AN AIR FRYER

(71) Applicant: Midea Group Co., Ltd., Foshan (CN)

(72) Inventors: Wei Youyang, Louisville, KY (US); Clayton James O'Donoghue, Shelbyville, KY (US); Jiajun Bi, Louisville, KY (US)

(73) Assignee: Midea Group Co., Ltd., Foshan (CN)

(21) Appl. No.: 18/771,650

(22) Filed: Jul. 12, 2024

(51) Int. Cl. A47J 44/00; A47J 37/06; A47J 43/08

(52) U.S. Cl. CPC A47J 44/00; A47J 37/0641; A47J 43/085

(57) ABSTRACT

A method and apparatus for a cooking appliance. The cooking appliance may include air frying in a heating compartment. The cooking appliance may include a blending cartridge. The blending cartridge may be in communication with the heating compartment. One or more circulating devices may be used to circulate air. A controller may be used to blend the contents of the blending container and transfer the blended contents within the appliance.

### BACKGROUND

The present embodiments relate to a method and apparatus for an air fryer appliance, more specifically an air fryer appliance with a blending cartridge.

Typical air fryers may air fry food in an air fryer heating compartment. However, this practice of using the air fryer heating compartment does not allow other or additional contents to be added to the varieties of food being air fried and at various times, and/or reduces the variety of food/flavors prepared. Thus, there is a need to blend and/or add blended contents to the food container/heating compartment of the air fryer.

### SUMMARY

In some embodiments, an air fryer appliance may include a housing defining a heating compartment. In various embodiments, the appliance may include a circulating device and/or a heating device in communication with the heating compartment to heat the contents by circulated air within the heating compartment. In some embodiments, the appliance may include a drive mechanism positioned within the housing. In various embodiments, the appliance may include a blending cartridge. In some embodiments, the blending cartridge may include a mixing assembly engageable to the drive mechanism within the housing. In some embodiments, the blending cartridge may be in fluid communication with the heating compartment.

In addition, in some embodiments, the blending cartridge may releasably engage the housing. In various embodiments, the air fryer appliance may include an injection system to discharge contents of the blending cartridge into the heating compartment. In some embodiments, the air fryer appliance may include one or more user interfaces to control at least one of the injection system, the drive mechanism, the circulating device, and/or the heating device. In various embodiments, the air fryer appliance may include a controller configured to control the heating device and/or the circulating device to circulate hot air to the contents within the heating compartment. In various embodiments, the air fryer appliance may include a controller configured to control the drive mechanism to mix the contents within the blending cartridge. In some embodiments, the controller may be configured to add blended contents from the blending cartridge to the heating compartment. In various embodiments, the blending cartridge may include a body defining an opening and a lid. In some embodiments, the lid may be removably attached to the body of the blending cartridge to at least one of open and/or close the opening. In various embodiments, the housing may include a receptacle positioned in a top wall therein to receive the blending cartridge. In some embodiments, the air fryer appliance may include one or more apertures in fluid communication between the blending cartridge and the heating compartment.

In some embodiments, a blending cartridge for an air fryer appliance may include a body having a first end and an opposing second end. In various embodiments, the second end may include a mixing assembly configurable to engage a drive mechanism of an air fryer appliance. In some embodiments, the mixing assembly may include one or more blades positioned within the body. In various embodiments the second end and/or body may include one or more apertures configurable between a closed position and an open position, when in the open position the contents are in fluid communication with an air fryer appliance and when in the closed position the contents are not in fluid communication with an air fryer appliance.

In addition, in some embodiments, the blending cartridge may include a lid and wherein the first end defines an opening. In various embodiments, the lid may be removably attached to the first end of the blending cartridge to open and/or close the opening of the first end. In some embodiments, the blending cartridge may include a plunger operably engaging the one or more apertures. In various embodiments, the plunger may be biased towards the closed position of the one or more apertures. In some embodiments, the second end may include a base releasably engaging the body. In various embodiments, the base may include the mixing assembly on one end and a drive interface on an opposing end configured to engage a drive mechanism of an air fryer appliance. In some embodiments, the blending cartridge may include an air fryer appliance, wherein the blending cartridge is releasably engagable to the air fryer appliance.

In some embodiments, a method of air frying food in a heating compartment within an air fryer appliance may include providing an air fryer appliance having a housing defining a heating compartment. In some embodiments, the appliance may include a circulating device and/or a heating device in communication with the heating compartment to heat the contents by circulated air within the heating compartment. In various embodiments, the appliance may include a drive mechanism positioned within the housing. In some embodiments, the appliance may include a blending cartridge having a mixing assembly engagable to the drive mechanism within the housing. In various embodiments, the blending cartridge may be in fluid communication with the heating compartment. In some embodiments, the method may include blending contents within the blending cartridge. In various embodiments, the method may include transferring the blended contents from the blending cartridge to the heating compartment.

In addition, in some embodiments, the method may include controlling the drive mechanism to drive the mixing assembly within the blending cartridge. In various embodiments, the method may include opening and/or closing one or more apertures between the blending cartridge and the heating compartment. In some embodiments, the method may include releasably engaging the blending cartridge to the housing of the air fryer appliance. In various embodiments, the method may include transferring the blended contents from the blending cartridge to the heating compartment before, during, and/or after heating air and/or circulating air. In some embodiments, blending the contents within the blending cartridge occurs before, during, and/or after heating air and/or circulating air.

These and other advantages and features, which characterize the embodiments, are set forth in the claims annexed hereto and form a further part hereof. However, for a better understanding of the embodiments, and of the advantages and objectives attained through its use, reference should be made to the Drawings and to the accompanying descriptive matter, in which there is described example embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of an embodiment of an air fryer appliance illustrating one embodiment of a blending cartridge in the engaged or stowed position;

FIG. 2 is a perspective view of FIG. 1 with the blending cartridge exploded away from the air fryer housing in the disengaged or deployed position;

FIG. 3 is a sectional view of the cooking appliance taken along line 3-3 of FIG. 1;

FIG. 3A is an enlarged view of FIG. 3;

FIG. 4 is a perspective view of one embodiment of the injection system and one or more drive mechanisms within the cooking appliance; and

FIG. 5 is a block diagram of an example control system for the air fryer appliance.

### DETAILED DESCRIPTION

Numerous variations and modifications will be apparent to one of ordinary skill in the art, as will become apparent from the description below. Therefore, the invention is not limited to the specific implementations discussed herein.

The embodiments discussed hereinafter will focus on the implementation of the hereinafter-described techniques and apparatuses within a residential cooking appliance such as cooking or air fryer appliance 10, such as the type that may be used in single-family or multi-family dwellings, or in other similar applications. As a non-limiting example, the cooking appliance 10 may be a counter-top cooking appliance having an air fryer heating compartment 20 and/or a blending cartridge 30. However, it will be appreciated that the herein-described techniques and apparatuses may also be used in connection with other types of cooking appliances in some embodiments. For example, the herein-described techniques may be used in commercial applications in some embodiments. Moreover, the herein-described techniques may be used in connection with various cooking appliance configurations.

As shown in the Figures, one or more cooking or heating compartments 20 may be used within a home cooking appliance 10, such as but not limited to a counter-top cooking appliance, having a housing 12 defining one or more cooking compartments, such as an air fryer cooking or heating compartment 20. In the one embodiment shown, the appliance 10 is generally used in a domestic setting and provides a means of preparing food for eating by circulating a flow of hot air around the food contents to heat and/or cook the food, provides a means for blending contents, and/or provides a means for transferring the blended contents to the food being heated and/or cooked. Such an apparatus includes an enclosed food preparation chamber or heating compartment 20 (e.g. air frying), into which food contents 1 are placed and a flow of hot air is then circulated around the food, until the food is cooked. The apparatus comprises a blending cartridge 30, into which contents 2 are placed/mixed/blended and/or transferred to the heating compartment 20/food 1. The contents 2 blended/transferred (e.g. sprayed onto food or into heating compartment/food container) may be a variety of substances/ingredients including, but not limited to, seasoning, barbecue sauce, spices, soy sauce, water, chili, salt, pepper, oil, etc. As will be described herein, the cooking appliance 10 can selectively utilize the blending container 30 to blend and/or transfer to the heating compartment 20 and/or food container 22 at one or more operations, times, cycles, and/or durations. Control over cooking appliance 10 by a user is generally managed through a control panel 93 typically disposed on a top or front of the housing 12, or portions thereof, and it will be appreciated that in different appliance designs, the control panel 93 may include various types of user interfaces 91 including various input and/or output devices, including various knobs, buttons, lights, switches, textual and/or graphical displays, touch screens, etc. through which a user may configure one or more settings and start and stop a blending cycle and/or transferring/spraying/discharging cycle in communication with the heating compartment 20 (e.g. food container 22).

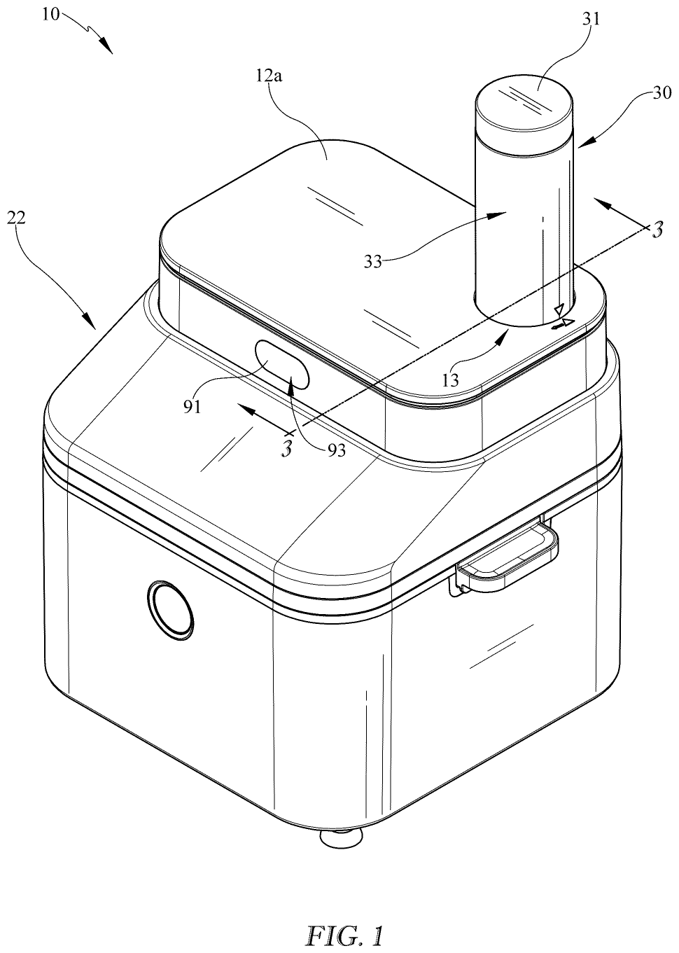

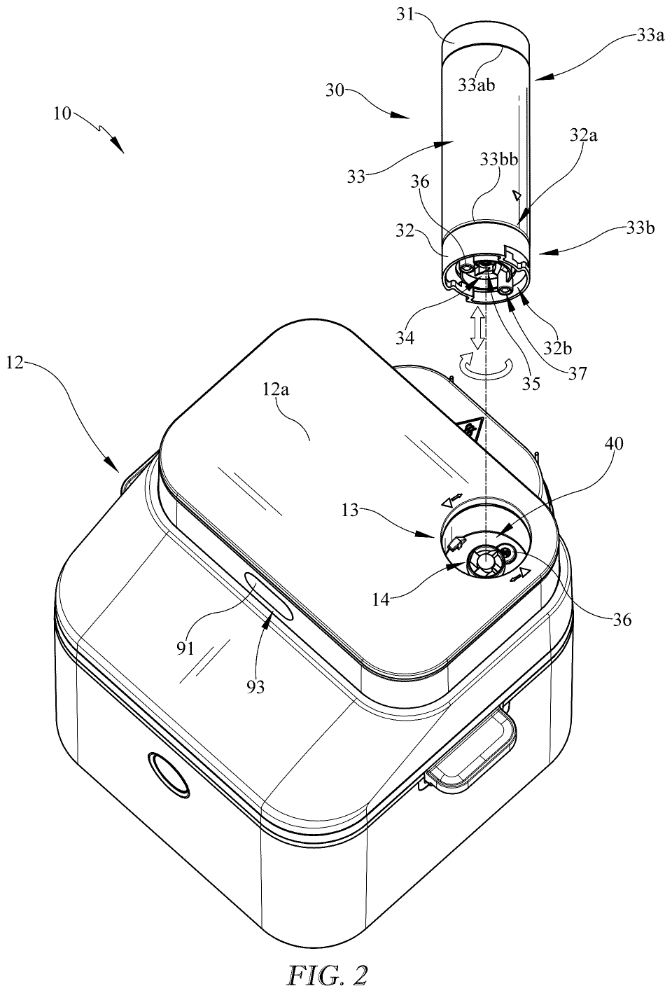

In some implementations, the housing 12 may include a plurality of heating compartments 20. The housing 12 may include one or more food containers 22 positioned in the heating compartment 20. In the one embodiment shown, the heating compartment 20 includes at least one food container 22 (e.g. drawer, basket, cavity, etc.). The heating compartment or air fryer heating compartment 20 may include the food container 22 (e.g. drawer). The housing 12 or heating compartment 20 may include an opening 21 (e.g. accessible via a hinged lid/door/top wall) removably receiving and/or positioning the food container 22. Although not shown, the container(s) or drawer may include rails or slides allowing the container/drawer to be accessible and/or removed. The container 22 may be configured between an open or deployed position (not shown) for the loading and unloading of their respective food product/contents 1, and a closed, stowed, or operating position when engaged with the housing 12 (FIGS. 1-3), In the open position, the container or drawer 22 may be detached or remain attached to the remainder of the housing 12 and still unload/load the food contents and/or water. The food containers 22, or portions thereof, may be deployed from the closed position towards another position (e.g. open position). The blended contents 2 and/or non-blended, if desired, may be transferred to the food container 22 and/or compartment 20 when the food container is in the stowed position, although the blended contents 2 may be added to the container/compartment when in the deployed position or position different from the stowed position. For example, blended contents may be transferred and/or the blending of contents within the blending container 30 may occur only when the food container is in the stowed position. For example, blended contents may be transferred and/or the blending of contents within the blending container 30 may occur when the food container is in the stowed position and/or deployed position.

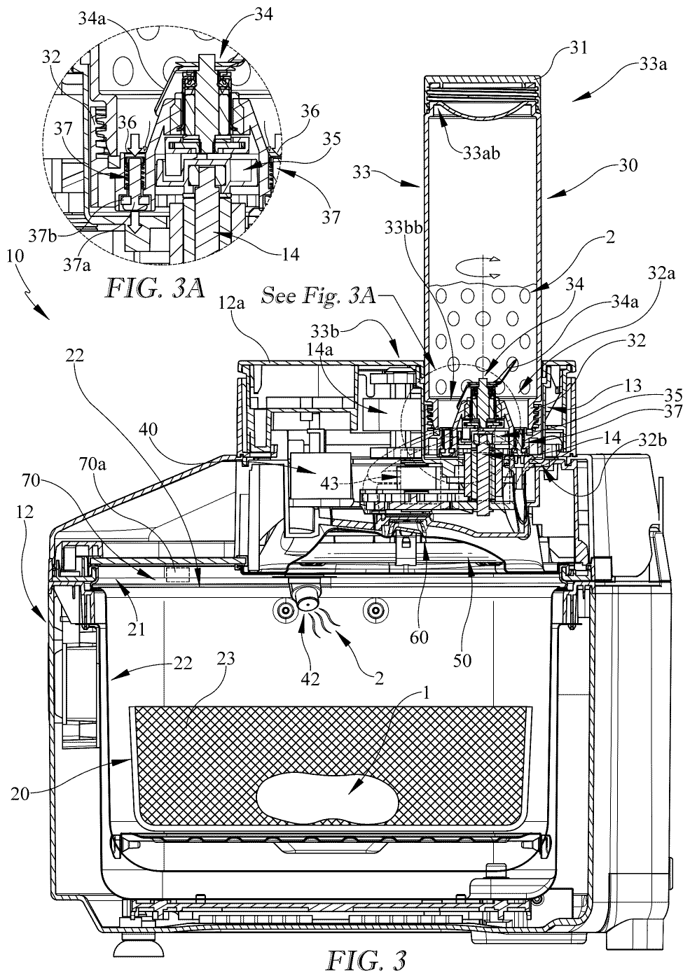

In some implementations, the food container 22 and/or housing 12 may include a lid/top wall 12a (e.g. hinged) accessing the food container 22/heating compartment 12 as shown in the one embodiment. Alternatively, a drawer may be used in some embodiments. In some embodiments, the container 22 may include a mesh container or basket 23 having an inner area that is sufficiently large to hold a specified quantity of food/contents 1. The mesh basket 23, if used, within the heating compartment may be relatively dense or loose, depending on the desired amount of access to air and/or blended contents that is desired within the basket itself. As shown more clearly in FIG. 3, the food container 22 may include a wire basket 23, if used. The basket 23, if used, may be made of materials other than mesh, such as a solid material sheet with perforations, for example, or other materials. One or more portions of the injection system 40 (e.g. sprayer(s) 42) may be positioned in the heating compartment 20/container 22. For example, one or more nozzles or sprayers 42 may be positioned in a variety of positions/orientations to discharge (e.g. one or more time periods) blended contents 2 of the blending cartridge 30 into the food container 22/compartment 20.

In some embodiments, the appliance 10 or one or more heating compartments 20 may include one or more heating devices 50 in communication therewith. As shown in the one embodiment, the heating compartment 20 includes one or more heating devices 50. The heating compartment 20 and/or housing 12 may include a heating device 50 in communication with the food container 22. A circulating device 60 (e.g. first motor, motor 14a, fan, etc.) may operate with the heating device 50 to communicate with the food container 22 or compartment 20 to heat the contents of the food container by circulating air (e.g. hot air). The heating device 50 and/or fan 60 may be positioned above or at a higher elevation than the heating compartment 20 or food container 22. The air may be heated with and/or without the blending container 30 (e.g. stowed, deployed) blending, when the blending cartridge 30 in the stowed position, when the blending cartridge 30 in the deployed position, and/or when the injection system 40 is discharging and/or not discharging contents 2 (e.g. blended, non-blended).

The heating device 50, circulating device 60, and/or injection system 40 may be a variety of positions within the appliance 10 or housing 12, quantities, shapes, sizes, and constructions.

In some implementations, one or more circulating devices 60 may be used to circulate air. The air may be circulated with and/or without one or more heating devices 50 heating or producing heat, and/or with and/or without the blending container 30 blending and/or injection system 40 discharging contents. The circulating device 60 may circulate air to and/or from one or more heating compartments 20 and/or food containers 22. In some embodiments as shown in the Figures, one or more fans 60 (e.g. a centrifugal fan, motor 14a) are provided generally adjacent to the heating device 50 to circulate the air (e.g. heated) through the housing 12 and into the heating compartment 20 or food container 22. The one or more circulating devices 60 may circulate air (e.g. heated) to and/or from the food container 22 or heating compartment 20 to air fry the contents therein. The air circulating device(s) 60 may circulate air to and/or away from the heating compartments 20 in some embodiments. The air circulating device 60 may be in fluid communication with one or more inlets and/or outlets of the housing 12. The air circulating device 60 may be a variety of sizes, shapes, quantities, positions, and constructions and still be within the scope of the invention.

In some implementations, cooking appliance 10 may include one or more blending cartridges/containers 30. The blending cartridge 30 (e.g. base 32, mixing assembly 34) may releasably engage the housing 12, receptacle 13, and/or drive mechanism 14 (e.g. motor 14a, third motor). The housing 12 may include one or more receptacles 13 to receive (e.g. releasably engage) the blending cartridge 30. As shown in the one embodiment, the receptacle 13, if used, may be positioned in a top wall 12a of the housing 12. Other positions are contemplated. The blending cartridge 30 may be configured between a stowed/engaged position with the housing 12 and a disengaged/deployed position with the housing 12. In the engaged positioned, the blending cartridge 30 may be in fluid communication with the food container/compartment. When in the engaged position as shown in FIGS. 1, 3, and 4, the contents within the blending container may be blended/mixed (e.g. via the drive mechanism 14) and/or transferred/communicated (e.g. via the injection system) to the food container 22/compartment 20 (e.g. downstream). The mixing assembly 34 (e.g. drive interface 35) operable engages or is engageable to the drive mechanism 14 of the receptacle 13 and/or housing 12 when in the stowed position. The drive mechanism 14 may be positioned within the housing 12 and/or receptacle 13. When in the disengaged position, the lid 31 and/or base 32 may be releasably disengaged from the body 33 to fill/remove/clean contents within the blending cartridge 30 (e.g. body 33). When in the engaged position, the lid 31 may be releasably disengaged from the body 33 to fill/remove/clean contents within the blending cartridge 30 (e.g. body 33).

In some implementations, the appliance 10 and/or blending cartridge 30, or portions thereof, may include a mixing assembly 34. The mixing assembly 34 may include one or more blades 34a as shown in the one embodiment. The mixing assembly 34 releasably engages the drive mechanism 14, the housing 12, and/or receptacle 13. The mixing assembly 34 may be positioned on one end 33a of the blending cartridge 30. The blending cartridge 30 may include a body 33. The body 33 and/or cartridge 30 may define a mixing volume therein (e.g. mixing assembly in communication with the volume). The one or more blades 34a may be positioned and/or rotate within the body 33 or volume. The body 33 and/or cartridge 30 may include a first end 33a and an opposing second end 33b. The first end 33a may define an opening 33ab (e.g. threaded). The lid 31 (e.g. threaded) may be removably/releasably attached to the body 33 (e.g. first end 33a). The lid 31 may open and/or close the opening 33ab/first end 33a/body 33. The second end 33b may define an opening 33bb (e.g. threaded). The base 32 may releasably engage the second end 33b or body 33. The base 32 may include the mixing assembly 34 (e.g. blades) on one end 32a and a drive interface 35 on the other end 32b connected to the mixing assembly 34 configured to engage (e.g. rotationally lock, releasably, when in the stowed position) the drive mechanism 14 (e.g. motor 14a) of the air fryer appliance 10/housing 12/receptacle 13.

In some implementations, the air fryer appliance 10 and/or blending cartridge 30 may include an injection system 40. The injection system 40 (e.g. pump/motor 43, sprayer 42, valve 37), if used, may discharge/transfer contents 2 of the blending cartridge 30 downstream into the heating compartment 20/food container 22. The injection system 40 may be in communication between the blending cartridge 30 (e.g. upstream) and the heating compartment 20/food container 22 (e.g. downstream). The injection system 40 may include one or more sprayers 42 positioned in the heating compartment 20. The injection system may include a water jet motor/pump 43. The water jet motor/pump 43 may use suction to pull contents 2 (e.g. blended, non-blended) from the cartridge 30 to the heating compartment 20 or sprayer 42. In should be understood that a variety of constructions of injection systems may be used. For example, one or more pumps/motors may be used.

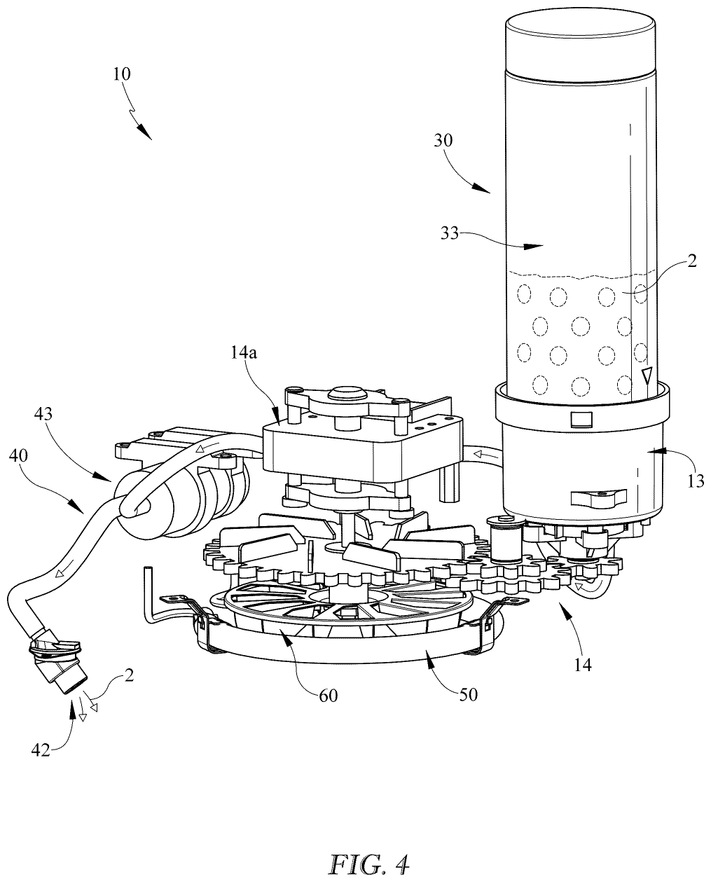

In some implementations, one or more drive mechanisms may drive one or more components (e.g. mixing assembly, injection system, circulating device) of the appliance 10. For example, the drive mechanism(s) may include one or more motors to drive the mixing assembly 34, injection system 40, and/or circulating device 60, or portions thereof. In some embodiments, the drive mechanism 14 may include a motor 14a to drive the mixing assembly 34, and/or may be used for other components such as, but not limited to, the injection system and/or air circulating device. For example, as shown in the one embodiment in FIG. 4, motor 14a (e.g. first, third) drives the air circulating device 60 and the mixing assembly 34. One or more gears may be used to connect the motor 14a to the mixing assembly 34 and the air circulating device 60 (e.g. fan). Although a second or another motor (e.g. water jet motor/pump 43) may be used for the injection system 40 as shown in the one embodiment, the first motor 14a may be used for the injection system 40 in some embodiments.

In some implementations, the air fryer appliance 10, injection system 40, and/or blending cartridge 30 may include one or more apertures 36. The one or more apertures 36 are in fluid communication with the blending cartridge 30, or portions thereof, and the injection system 40, air fryer appliance 10, and/or heating compartment 20/food container 22. The blending cartridge 30, base 32, body 33, mixing assembly 34, opening 33bb, and/or second end 33b may include one or more apertures 36. As shown in the one embodiment, the blending cartridge 30 or base 32 (e.g. second end 33b) includes the one or more apertures 36. The apertures 36 may extend through the base 32, from one end 32a to an opposing end 32b. The apertures 36, if used, may communicate with the volume/body 33 and the injection system 40/housing 12/sprayer 42/compartment 20. The aperture(s) may be configurable between a closed position and an open position. When in the open position as shown in FIG. 3A, the contents 2 of the blending cartridge 30 may be in fluid communication with the air fryer appliance 10, injection system 40, and/or heating compartment 20, or portions thereof. The aperture(s) may be unsealed when in the open position. When in the closed position as shown in FIG. 3, the contents 2 of the blending cartridge 30 may not be in fluid communication with the air fryer appliance 10 and/or heating compartment 20, or portions thereof. The aperture(s) may be sealed in the closed position.

In some implementations, the air fryer appliance 10, injection system 40, one or more apertures 36, and/or blending cartridge 30 may include one or more valves 37. The valve(s) 37 may open and/or close the one or more apertures 36 and/or may be configured to control the fluid communication between the blending cartridge 30 and the air fryer appliance 10, injection system 40, and/or heating compartment 20, or portions thereof. In the one embodiment shown in the Figures, the valve 37 may be a plunger 37a. The plunger may operably engage the aperture(s) 26 as shown in FIGS. 3 and 3A. The plunger 37a, if used, may be spring loaded or biased (e.g. spring) towards the closed position as shown in FIG. 3 (e.g. injection system 40, aperture 26) to close the aperture 26. When enough suction/pressure is generated (e.g. via the water jet motor/pump 43), the spring is compressed such that the aperture 26, injection system 40, and/or plunger 37a is moved to the open position as shown in FIG. 3A allowing the contents 2 to be transferred to the heating compartment 20/container 22/injection system 40. The pressure may also spray the contents 2 (e.g. blended, non-blended) via the sprayer 42 towards the food contents 1. Although pressure may be used to operate the one or more valves 37 (e.g. plunger 37a), it should be understood that a variety of mechanisms/ways may be used. For example, switches/sensors may be used in some embodiments.

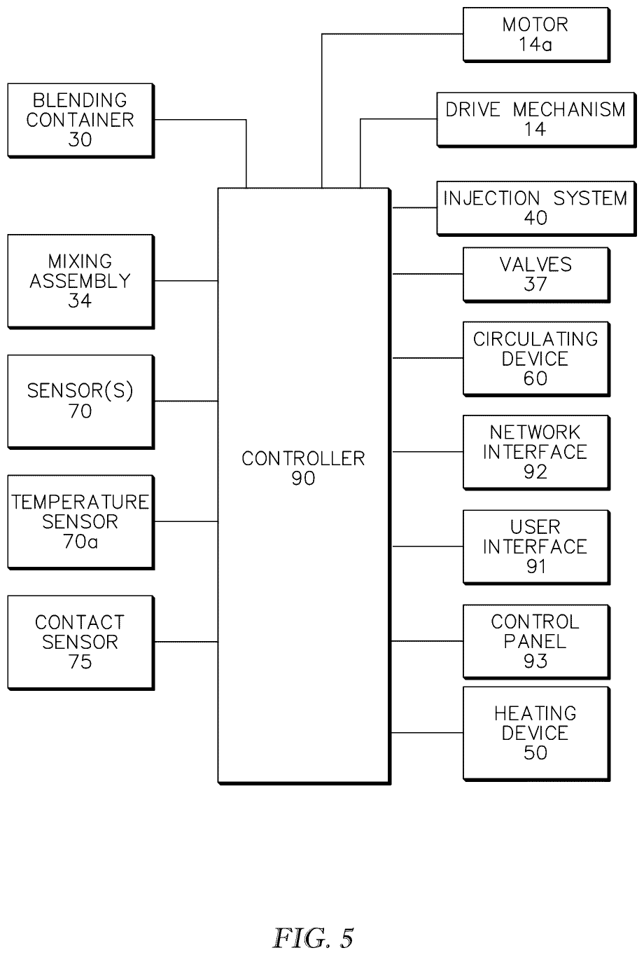

In some implementations as shown in FIG. 5, cooking appliance 10 may be under the control of a controller 90 that receives inputs from a number of components and drives a number of components in response thereto. Controller may for example, include one or more processors and a memory (not shown) within which may be stored program code for execution by the one or more processors. The memory may be embedded in the controller, but may also be considered to include volatile and/or non-volatile memories, cache memories, flash memories, programmable read-only memories, read-only memories, etc., as well as memory storage physically located elsewhere from controller, e.g., in a mass storage device or on a remote computer interfaced with controller.

The controller 90 may be interfaced with various components of the cooking appliance 10, to control one or more air frying cycles, motor(s), fans, injection cycles, and/or blending cycles to cook food contents in the one or more heating compartments. In some implementations, the heating device 50 and/or circulating device 60 may circulate air (e.g. air or hot air) to the food contents 1 within the food container 22 or heating compartment 20 during at least a portion of the one or more air frying cycles. In some embodiments, the blending cartridge 30 and/or appliance 10 may blend the food contents 2 within the blending cartridge 30 before, after, and/or during at least a portion of the one or more air frying cycles (e.g. injection, heating, circulating). In some embodiments, the injection system 40 may transfer/communicate the food contents 2 from the blending cartridge 30 before, after, and/or during at least a portion of the one or more air frying cycles (e.g. heating, blending, circulating). In some implementations, the heating device(s) 50 may radiate heat or heat the food at the same, different, or overlapping time period(s), or portion of the timer period, relative to the drive mechanism 14/blending to cook the respective food in their corresponding compartments.

The controller 90 may be coupled to the heating device 50, the circulating device 60, blending container 30, injection system 40, drive mechanism 14, mixing assembly 34, or portions of the cooking appliance 10, to circulate air (e.g. hot air), heat air, and/or mix/transfer cartridge contents 2 to the contents 1 within the food container 22/heating compartment 20 for one or more air fryer cycles. The controller 90 may blend/transfer the contents 2 to the food container 22/compartment 20 for the one or more time periods. The controller 90 may be configured to control the heating device and the circulating device to circulate hot air to the contents within the food container. The controller may be configured to control the drive mechanism 14 and/or mixing assembly 34, or portions thereof, to mix the contents within the blending cartridge. Controlling the drive mechanism 14 may drive the mixing assembly 34 within the blending cartridge 30. The controller may be configured to control the injection system 40 (e.g. valves, apertures, motors, pumps, sprayers), or portions thereof, to transfer the contents from the blending cartridge to the food container/heating compartment. The controller 90 may control the opening and/or closing of the one or more apertures 36 and/or valves 37. It should be understood that the circulating device 60 (e.g. fan, motor) may operate at one or more time intervals before, during, and/or after the heating device 50/injection system 40/mixing assembly 34 is activated in a variety of air fryer cycles. The controller 90 may control the heating device to activate/deactivate when the air is circulating and/or is not circulating during a cycle.

The controller 90 may be coupled to the blending cartridge 30, or portions of the cooking appliance 10, to blend and/or transfer/communicate the contents 2 within the blending cartridge 30 to the food container 22/heating compartment 20 for one or more air frying/blending/transferring cycles. The controller 90 may operate the drive mechanism 14 and/or mixing assembly 34 for one or more time periods. The controller 90 may control the one or more valves 37/apertures 36/injection system 40, or portions thereof. The controller 90 and/or user may activate/deactivate the blending and/or transfer. More particularly as shown in FIG. 4, the controller 90 may be coupled to one or more sensors 70 such as a temperature sensor 70a, if used, in order to control and/or determine the temperature of the food contents 1/2, heating device 50, food container 22, and/or heating compartment 20. If used, the temperature may be used to determine the food/container and/or compartments temperature or verify when the food contents are cooked as desired.

Additional sensors and actuators may also be used in some embodiments, including a contact sensor, or micro switch 75 to determine when the blending container 30 is in the closed/stowed position and/or open/deployed position. In some embodiments such a contact sensor may be disposed on or in cooking appliance 10, receptacle 13, and/or blending cartridge 30 (e.g. base), or variety of positions within the housing 12. In some embodiments, the one or more micro switches, if used, may be configured to detect if one or more of the blending cartridges is deployed and/or stowed within the housing. These micro switches, if present, may be actuated through minimal physical force/contact by the one or more containers/cartridges by use of a tipping-point mechanism, and as such they may, in some instances, be desirable for the detection of a location and/or presence of a cartridge. One or more parameters of the blending, heating, circulating, transferring, and/or air fryer cycles may be configured based on the one or more sensors, or contact sensor. As a non-limiting example, the contact sensor, if used, may be desirable to detect the cartridge in the closed position to activate the one or more blending cycles and/or injection cycles of the respective blending cartridge/appliance. Further, the detection of the blending cartridge away from the closed position (e.g. open or deployed position) may deactivate and/or pause the one or more cycles of the respective appliance/cartridge. Moreover, controller 90 may be coupled to a user interface 91/control panel 93 including various input/output devices such as knobs, dials, sliders, switches, buttons, lights, textual and/or graphics displays, touch screen displays, speakers, image capture devices, microphones, etc. for receiving input from and communicating with a user. The user interface(s) 91 may control at least one of the injection system 40 (e.g. water jet motor/pump), drive mechanism(s) 14, mixing assembly 34, circulating device 60, and/or heating device 50. In some embodiments, controller 90 may also be coupled to one or more network interfaces 92, e.g., for interfacing with external devices via wired and/or wireless networks such as Ethernet, Bluetooth, NFC, cellular and other suitable networks.

Moreover, in some embodiments, at least a portion of controller 90 may be implemented externally from a cooking appliance, e.g., within a mobile device, a cloud computing environment, etc., such that at least a portion of the functionality described herein is implemented within the portion of the controller that is externally implemented. In some embodiments, controller may operate under the control of an operating system and may execute or otherwise rely upon various computer software applications, components, programs, objects, modules, data structures, etc. In addition, controller may also incorporate hardware logic to implement some or all of the functionality disclosed herein. Further, in some embodiments, the sequences of operations performed by controller to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

In some implementations, the blending cartridge 30 and/or appliance 10, or portions thereof, may include one or more sealing mechanisms. One or more sealing mechanisms (e.g. gaskets, O-rings) may seal the blending cartridge 30 (e.g. between cartridge and housing), one or more apertures 36, and/or valves 37 when in the closed position. For example, the plunger 37a may carry a seal 37b therewith between the closed and open positions relative to the aperture 36. Further, for example, the base 32 and/or lid 31 may include one or more seals between the remainder of the body 33 and/or openings 33bb, 33ab, respectively.

In some implementations, the blending cartridge 30 and/or appliance 10, or portions thereof, may include one or more mating features. The mating features, if used, may include, but are not limited to, the drive shaft/mechanisms 14, drive interface 35, axial-locking mechanism between cartridge and the housing, anti-rotation features (e.g. between the housing and cartridge/body, between the drive mechanism of the housing and the drive interface of the cartridge), bearings, bushings, and/or safety power shut-off switch of the housing, etc. For example, the cartridge may include a push and turn engagement with the receptacle (e.g. retention devices) to axial-lock the axial position therebetween when in the stowed position. The blending cartridge 30, mixing assembly 34, and/or body 33 (e.g. base) may releasably engage the drive mechanism 14 and/or other features of the housing 12 of the air frying appliance.

In use, in some implementations, a food product 1, if desired to be cooked (e.g. air frying), may be positioned or placed into the air fryer or food container 22. In various embodiments, a food product(s) 2, if desired, may be positioned or placed in the blending cartridge and subsequently positioned to the closed/stowed position with the housing 12. A lid 31, if used, may cover the contents 2 of the blending cartridge 30. The blending cartridge 30 may be releasably engaged to the housing 12/appliance 10, or portions thereof. The blending cartridge 30 may by filled with contents 2 before or after assembly/engagement/stowing to the housing 12. The controller may be used to turn on and/or off the air fryer cycle/function, the transferring cycle, and/or the blending cycle/function. With the detection of the location and/or presence of a drawer/basket/container 22 and/or blending cartridge 30 by the one or more contact switches, if used, the blending cycle, transferring cycle, and/or air fryer cycle may be selected by the user and/or the heating may be activated, etc. The food product 1 may be cooked by the heated and/or circulated air. The heating device 50 and/or circulating device 60 may operate for a time period. The contents 2 may be blended within the blending cartridge for a time period (e.g. same and/or different as the heating/circulating/transferring time period). The contents 2 (e.g. blended) may be transferred from the blending cartridge to the food container 22/heating compartment 20. The opening/closing of one or more apertures 36 and/or valves 37 (e.g. between the blending cartridge and the container/compartment) may transfer/communicate the contents 2 between positions within the appliance 10. The contents 2 may be blended before, during, and/or after transferring contents (e.g. injecting, communicating), heating the air, and/or circulating the air (e.g. heated). The contents 2 (e.g. blended, non-blended) may be transferred from the blending cartridge 30 before, during, and/or after heating the air and/or circulating the air (e.g. heated). In some embodiments, the operation of one or more cooking components may not overlap in some embodiments.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. An air fryer appliance comprising:
a housing defining a heating compartment;
a circulating device and a heating device in communication with the heating compartment to heat the contents by circulated air within the heating compartment;
a drive mechanism positioned within the housing; and
a blending cartridge, wherein the blending cartridge includes a mixing assembly engageable to the drive mechanism within the housing, and wherein the blending cartridge is in fluid communication with the heating compartment.

2. The air fryer appliance of claim 1 wherein the blending cartridge releasably engages the housing.

3. The air fryer appliance of claim 1 further comprising an injection system to discharge contents of the blending cartridge into the heating compartment.

4. The air fryer appliance of claim 3 further comprises one or more user interfaces to control at least one of the injection system, the drive mechanism, the circulating device, and/or the heating device.

5. The air fryer appliance of claim 1 further comprising a controller configured to control the heating device and the circulating device to circulate hot air to the contents within the heating compartment, and configured to control the drive mechanism to mix the contents within the blending cartridge.

6. The air fryer appliance of claim 5 wherein the controller is configured to add blended contents from the blending cartridge to the heating compartment.

7. The air fryer appliance of claim 1 wherein the blending cartridge includes a body defining an opening and a lid, wherein the lid is removably attached to the body of the blending cartridge to at least one of open and/or close the opening.

8. The air fryer appliance of claim 1 wherein the housing includes a receptacle positioned in a top wall therein to receive the blending cartridge.

9. The air fryer appliance of claim 1 further comprising one or more apertures in fluid communication between the blending cartridge and the heating compartment.

10. A blending cartridge for an air fryer appliance comprising:
a body having a first end and an opposing second end; and
the second end includes a mixing assembly configurable to engage a drive mechanism of an air fryer appliance, wherein the mixing assembly includes one or more blades positioned within the body, and one or more apertures configurable between a closed position and an open position, when in the open position the contents are in fluid communication with an air fryer appliance and when in the closed position the contents are not in fluid communication with an air fryer appliance.

11. The blending cartridge of claim 10 further comprising a lid and wherein the first end defines an opening, and wherein the lid is removably attached to the first end of the blending cartridge to open and/or close the opening of the first end.

12. The blending cartridge of claim 10 further comprising a plunger operably engaging the one or more apertures, wherein the plunger is biased towards the closed position of the one or more apertures.

13. The blending cartridge of claim 10 wherein the second end includes a base releasably engaging the body, wherein the base includes the mixing assembly on one end and a drive interface on an opposing end configured to engage a drive mechanism of an air fryer appliance.

14. The blending cartridge of claim 10 further comprising an air fryer appliance, wherein the blending cartridge is releasably engagable to the air fryer appliance.

15. A method of air frying food in a heating compartment within an air fryer appliance comprising the steps of:
providing an air fryer appliance having a housing defining a heating compartment, a circulating device and a heating device in communication with the heating compartment to heat the contents by circulated air within the heating compartment, a drive mechanism positioned within the housing, a blending cartridge having a mixing assembly engagable to the drive mechanism within the housing, and wherein the blending cartridge is in fluid communication with the heating compartment;
blending contents within the blending cartridge; and
transferring the blended contents from the blending cartridge to the heating compartment.

16. The method of claim 15 further comprising controlling the drive mechanism to drive the mixing assembly within the blending cartridge.

17. The method of claim 15 further comprising opening and/or closing one or more apertures between the blending cartridge and the heating compartment.

18. The method of claim 15 further comprising releasably engaging the blending cartridge to the housing of the air fryer appliance.

19. The method of claim 15 further comprising transferring the blended contents from the blending cartridge to the heating compartment before, during, and/or after heating air and/or circulating air.

20. The method of claim 15 wherein blending the contents within the blending cartridge occurs before, during, and/or after heating air and/or circulating air.
